(19) United States
(12) Patent Application Publication
(10) Pub. No.: US 2016/0033418 A1
(43) Pub. Date: Feb. 4, 2016

(54) COMBINATION GLOVE FOR DETECTING BREACH OF HYDROPHILIC FLUID

(71) Applicant: Ansell Limited, Richmond (AU)

(72) Inventors: Aik Hwee Eng, Petaling Jaya (MY); Thanabalan Thannimalai, Melaka (MY); Albert Khor, Taman Sri Muda (MY); Lok Si Tang, Subang Jaya Selangor (MY); Thi Hao Pham, Shah Alam (MY); David M. Lucas, Kuala Lumpur (MY); Anthony Lopez, Somerset, NJ (US); Choy Yuen Chak, Petaling Jaya (MY)

(21) Appl. No.: 14/806,132

(22) Filed: Jul. 22, 2015

Related U.S. Application Data
(60) Provisional application No. 62/027,364, filed on Jul. 22, 2014.

(51) Int. Cl. G01N 21/78; A41D 19/00

(52) U.S. Cl. CPC G01N 21/78; A41D 19/0055; A41D 19/0006; A41D 19/0024

(57) ABSTRACT

Provided for example is a combination glove comprising: (a) an top elastomer layer with an inner surface, the top elastomer layer being translucent or transparent; (b) an bottom elastomer layer with an outer surface, the bottom elastomer layer being darker than the top elastomer layer; and (c) a space or seam between the layers, wherein to either the inner-top or the outer-bottom surface has been adhered a hydrophilicity promoting composition of (i) a polyvinyl alcohol or (ii) an alkyl-aryl compound or a siloxane compound having a pendent one to two oxy-polymers, or (iii) a quaternary amine including an alkyl of C8 to C24, wherein the oxy-polymer is (1) a poly-oxyalkylene polymer that is predominantly oxyethylene or (2) a polyvinyl alcohol, wherein the hydrophilicity promoting composition enhances the spreading in the space or seam of any of the hydrophilic or aqueous fluid that breaches the top or bottom elastomer layer.

Embodiments of the present invention generally relate to combination gloves for detecting fluid leakage through an outer or inner glove of the combination.

In detecting the leakage of aqueous fluids, it is known to utilize double gloves of elastomer materials with space allowing fluid to flow in between the layers. The elastomers of the layers typically have contrasting color so that a fluid collected between the two layers changes the visual impact. See, U.S. Pat. No. 5,224,221 and U.S. Pat. No. 5,524,294. Nonetheless, in the surgical setting, the visual obstruction caused by blood, and the low visual impact of the contrasts obtained have meant the breaches are not infrequently un-noticed by the medical users. Caillot et al., World J Surg. 2006 January; 30(1):134-8. Venables, US Patent Application 2012/0090074, describes a double glove system which seeks to enhance the contrast obtained upon breach, but nonetheless comes up short.

Therefore, a need exists for a combination glove having improved detection of a breach of an outer or inner elastomer layer by a hydrophilic fluid.

### SUMMARY

The combination glove of the invention has two glove components, an outward or top glove, and an inward or bottom glove. It will be understood that the combination can be worn with other gloves, generally gloves worn inward of the bottom glove.

Provided, among other things, is a combination glove for detecting breaches of hydrophilic or aqueous fluid comprising: (a) an top elastomer layer with an inner surface, namely the inner-top surface, the top elastomer layer being translucent or transparent; (b) an bottom elastomer layer with an outer surface, namely the outer-bottom surface, the bottom elastomer layer being darker than the top elastomer layer; and (c) a space or seam between the layers in which the hydrophilic or aqueous fluid can flow, wherein to either the inner-top or the outer-bottom surface has been applied a hydrophilicity promoting composition of (i) a polyvinyl alcohol or (ii) an alkyl-aryl compound or a siloxane compound with the foregoing having pendent one to two oxy-polymers, (iii) a quaternary amine including an alkyl of C8 to C24, or (iv) a mixture of the foregoing, wherein the oxy-polymer is (1) a poly-oxyalkylene polymer that is predominantly oxyethylene or (2) a polyvinyl alcohol, wherein the hydrophilicity promoting composition enhances the spreading in the space or seam of any of the hydrophilic or aqueous fluid that breaches the top or bottom elastomer layer. In embodiments, the hydrophilicity promoting composition further comprises a hydrophilic compound of carbon, hydrogen and oxygen wherein the carbon number is 2 to 8, such as a polyol. It will be understood that not all of the compound quantities in a hydrophilicity promoting composition applied to an elastomer surface will necessarily become associated with the surface, and that the volatile compounds will substantially be removed in the application process.

Further provided is a method of conducting surgery comprising: (a) a surgical worker donning a said combination glove; and (b) conducting a medical procedure in which the combination glove is exposed to biological fluids from a patient. The method can further comprise (c) the surgical worker removing the combination glove and replacing it with a second combination glove when the first combination glove darkens consistent with there being aqueous fluid between the top and bottom elastomer layers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A shows a comparative glove combination after dipping in water for 30 seconds; FIG. 1B shows the glove combination 5 minutes after the dipping;

FIG. 2A shows a comparative glove combination after dipping in water for 30 seconds; FIG. 2B shows the glove combination 5 minutes after dipping;

FIG. 3A shows a comparative glove combination after dipping in water for 30 seconds; FIG. 3B shows the glove combination 5 minutes after dipping;

FIG. 4A shows a comparative glove combination after dipping in water for 30 seconds; FIG. 4B shows the glove combination 5 minutes after dipping;

FIG. 5A shows a glove combination of the invention after dipping in water for 30 seconds; FIG. 5B shows the glove combination of the invention 5 minutes after dipping;

FIG. 6A shows a glove combination of the invention after dipping in water for 30 seconds; FIG. 6B shows the glove combination of the invention 5 minutes after dipping;

FIG. 7A shows a glove with a useful outer treatment; and

FIG. 7B shows the glove without the treatment.

While the invention is described herein by way of example using several embodiments and illustrative drawings, those skilled in the art will recognize that the invention is not limited to the embodiments of drawing or drawings described. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims.

The headings used herein are for organizational purposes only and are not meant to be used to limit the scope of the description or the claims. Also, as used throughout this application, the word “may” is used in a permissive sense (i.e., meaning having the potential to), rather than the mandatory sense (i.e., meaning must). Similarly, the words “include,” “including,” and “includes” mean including, but not limited to. The word “glove” means glove or glove liner.

### DETAILED DESCRIPTION

### First Inner-Top or Outer-Bottom Surface

As described above, one of the inner-top or the outer-bottom surfaces in the combination is treated to render it hydrophilic. In embodiments, it is the inner-top surface, i.e., the outer surface of the inner glove.

The polyvinyl alcohol is substantially hydrolyzed to reveal 80% or more (such as 90% or more, or 95% or more, or 98% or more) of the hydroxyl groups. The degree of polymerization can be from about 100 to about 3000. For example, the polyvinyl alcohol can be Exceval RS2117 (degree of polymerization 1,700, 99% hydrolysed) or Exceval HR3010 (degree of polymerization 1,000, 98% hydrolysed). Exceval polymers from Kuraray America Inc., Houston, Tex. In embodiments, the polyvinyl alcohol is used in conjunction with the hydrophilic compound such as polyol described below. In embodiments, the polyvinyl alcohol has an ethylene repeat along the main polymer chain.

In embodiments, for an alkyl-aryl compound having a pendent, from aryl, one to two oxy-polymers, the alkyl groups on the aryl are 1 to 2 in number, such as 1. In embodiments, one or more such alkyl is on average C16 or C17 or higher, such as C16 to about C32. In embodiments, one or more such alkyl is on average C8 or C10 or higher. In embodiments, the alkyl-aryl compound is used in conjunction with the hydrophilic compound such as polyol described below.

In embodiments, for siloxane compound having pendent one to two oxy-polymers, the compound is soluble in water. In embodiments, the siloxane is has 2 to 8 Si. In embodiments, the siloxane is oxides not linked to oxy-polymer are modified with C1 to C3 alkyl. In embodiments, the siloxane compound is used in conjunction with the hydrophilic compound such as polyol described below.

The oxy-polymer is present in 1 to 2 pendent groups, such as one. In embodiments, the oxy-polymer element(s) ((i) a poly-oxyalkylene polymer that is predominantly oxyethylene or (ii) a polyvinyl alcohol) on the alky-aryl compound has from about 8 to about 200 repeats, such as about 30 to about 100 repeats. The alkylene in poly-oxyalkylene polymer is ethylene or propylene. In embodiments, the poly-oxyalkylene polymer is polyoxyethylene. In embodiments, aryl is C6 or C10. In embodiments, aryl has carbon ring atoms. In embodiments, aryl is C6. The linkage of aryl or siloxane to oxy-polymer is via an oxy bridge, or C1-C4 alkyl to oxy to the residue of oxy-polymer.

The quaternary amine has two to three alkyl substitutions of C1 to C2, and one to two alkyl of C8 to C24. In embodiments, the quaternary amine is used in conjunction with the hydrophilic compound such as polyol described below.

For example, one class of silicone compound modified with oxy-polymer is 2-[acetoxy(polyethyleneoxy)propypeptamethyltrisiloxane (CAS No. 125997-17-3; AKA 3-(3-Hydroxypropyl)-heptamethyltrisiloxane, ethoxylated, acetate):

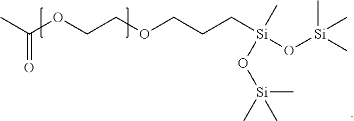

Another example is polyalkyleneoxide modified heptamethyltrisiloxane (CAS No. 27306-78-1):

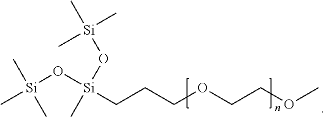

Another example is 3-(3-Hydroxypropyl) -heptamethyltrisiloxane, ethoxylated, Hydroxy-terminated (CAS No. 67674-67-3):

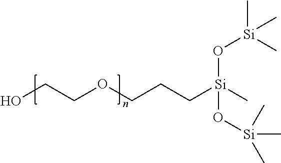

By a “hydrophilic” compound of carbon, hydrogen and oxygen wherein the carbon number is 2 to 8, it is meant that the compound (a) has a Log P_{octanol/water} of −0.7 or lower (a 5:1 preference for water over octanol or higher) or (b) has a HLB (Hydrophilic-lipophilic balance) value >10. In embodiments, “hydrophilic is measured by LogP. In embodiments, “hydrophilic is measured by HLB. In embodiments, the hydrophilic compound is a di, tri or per-hydroxylated compound of C2 to C4, such as a polyol (such as glycerol, propylene glycol, 1,3-Butanediol, 1,2-Pentanediol, 1,2-hexanediol, or sorbitol) or sodium lactate.

### Second Inner-Top or Outer-Bottom Surface

In embodiments, the other of the inner-top or the outer-bottom surfaces in the combination is treated to render it hydrophobic. For example, it can comprise a sublayer of film-forming polymer (such as polyurethane) and wax, such as described in U.S. Pat. No. 6,709,725, which is incorporated herein in its entirety for its teachings on making a hydrophobic surface. As discussed in the '725 patent, the treatment to render hydrophobic can include contacting the sublayer with a silicone/surfactant emulsion.

In embodiments, the inner surface of the inner glove is treated to render it hydrophobic, such as described in U.S. Pat. No. 6,709,725.

### Outer Glove, Outer Surface

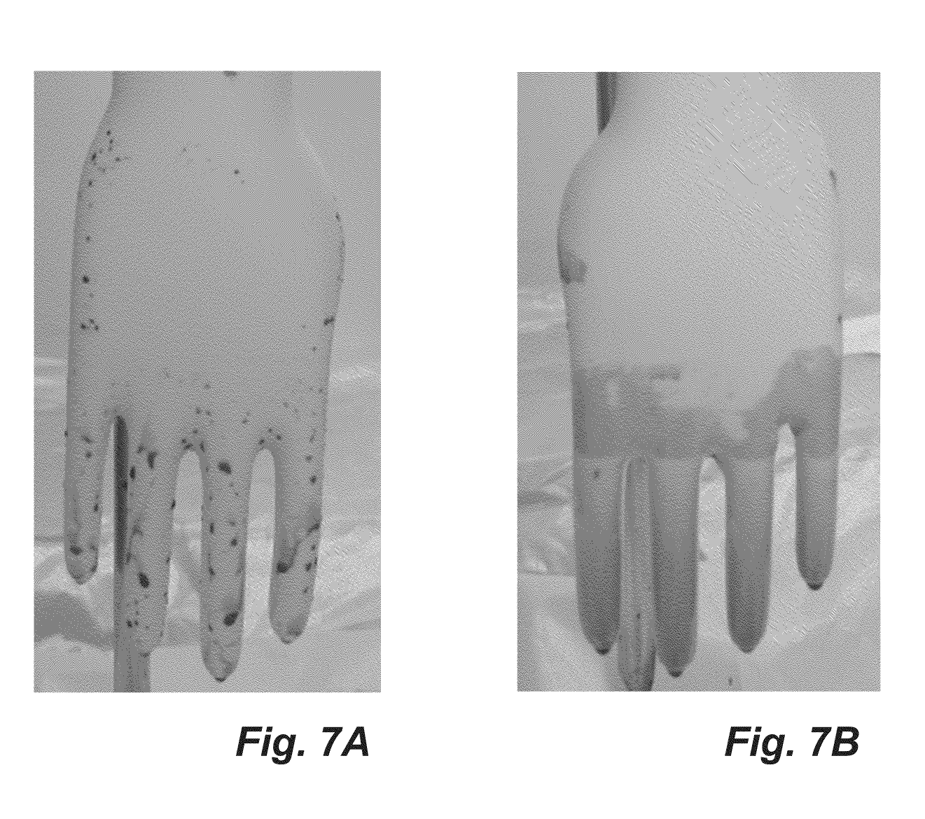

In embodiments, the outer surface of the outer glove of the combination glove of the invention has been treated to increase water-repellency. In embodiments, that treatments is with fluorocarbon compounds. In embodiments, the treatment is with hydrophobic particles in combination with fluorocarbon compounds, optionally in further combination with wax compounds, as described in U.S. Ser. No. 14/107,420, filed 16 Dec. 2013. In embodiments, the treatment is with hydrophobic particles in combination with fluorocarbon compounds, optionally in further combination with wax compounds, in combination with an overlaying treatment with a silicone composition, such as described in U.S. Ser. No. 14/107,420. U.S. Ser. No. 14/107,420 is incorporated herein in its entirety for its teachings on these surface treatments. FIG. 7 shows a PI glove with (A) and without (B) without such a treatment immediately after being soaked in human blood for 15 minutes and withdrawn.

The high contrast indicator provide by the combination glove is more useful in a surgical setting if the outer glove is relatively free of obscuring blood. Hence, the surface treatments described herein can enhance breach detection.

The combination of coatings according to embodiments of the invention forms a barrier coating that is differentiated from prior repellent coatings based on conventional fluorine chemistry. Barriers coatings in accordance with the invention comprise a fluid repellency treatment providing a rough, 3D surface structure on which hydrophobic particles, for example, silica (silicon dioxide) micro-particles, are deposited onto a flexible substrate, thereby creating a super fluid repellent effect.

Embodiments according to the invention comprise a highly effective combination for increasing the fluid repellency of elastomeric barriers, which may be used with elastomeric polymers of the type used for forming flexible surgical gloves, such as without limitation natural rubber (NR), polychloroprene (CR), acrylonitrile butadiene copolymer (NBR) (such as carboxylated acrylonitrile butadiene copolymer), polyisoprene (PI), polyurethane (PU), styrene-butadiene, butyl rubber (copolymer of isobutylene with isoprene, or polymer of isobutylene), or combinations thereof.

Silicone coatings that can be used with embodiments according to the invention include a formulation comprising a dimethicone emulsion, or a formulation comprising a cationic emulsion of an amine-functional silicone polymer, or a combination thereof, or one of the foregoing in combination with wax emulsion. The was can be, for example, a synthetic wax, such a polyethylene or polypropylene wax. The wax can be non-ionic.

Microparticle dispersions that can be used with embodiments according to the invention include wherein the hydrophobic micro-particles can be those described in, for example, US Publ. No. 2010/0112204, US Publ. No. 2010/0159195, or U.S. Pat. No. 7,056,845, the entire disclosures of which are herein incorporated by reference in their entireties. The micro-particles of US Publ. No. 2010/0112204 are reacted with linking reagents, followed by reaction with hydrophobic groups that attach to the resultant linking groups. Hydrophobic entities include C3-C24 hydrocarbon or C2-C12 perfluorinated carbon backbones. The micro-particles may also comprise nanoparticles, so long as the ability to induce a lotus effect with water is retained. For example, the size range can be 0.01 to 10 micrometers. Other micro-particles include silica particles.

Hydrophobic chemicals for use with embodiments of the invention also include known commercial products, for example, Softgard M3 (soft chemicals, Italy), Oleophobol 7752 (Huntsman, Germany), Ruco-Gard AIR and Ruco-Dry DHY (Rudolf Chemie, Germany), Scotchgard® (3M Inc., Maplewood, Minn.), Zepel-B™ (Dupont, Wilmington, Del.), anionic perfluoropolyether based polyurethane and polytetrafluoroethylene (Fluorolink® 5049), and perfluoropolyether based triethosilane (Fluorolink® S10, available from Ausimont, Thorofare, N.J.), perfluoroalkyl acrylic co-polymer (such as Zonyl® 8300 available from Ciba Specialty, High Point, N.C.; and Scotchban™ FC-845 available from 3M, St. Paul, Minn.), perfluoroalkyl urethane (such as L-8977 available from 3M, St. Paul, Minn.), perfluoropolyether-modified polyurethane dispersion (such as Fluorolink™ P56 available from Ausimont, Thorofare, N.J.), fluorinated silicone polyester (such as Lambent™ WAX available from Lambent Technologies, Fernandina Beach, Fla.), polychlorotrifluoroethylene (such as Aclon™ PCTFE available from Honeywell, Morristown, N.J.), polyvinylidene fluoride dispersion (such as Unidyne™ TG available from Daikin America, New York, N.Y.), tetrafluoroethylene-hexafluoropropylene co-polymer (such as Dyneon™ FEP available from 3M, Parsippany, N.J.), polyperfluoroethoxymethoxydifluoroethyl PEG phosphate (such as Fomblin™ HC/2-1000 available from Solvay Solexis, Houston, Tex.), Oleophobol® CP-SLA (an aqueous dispersion of perfluorinated acrylic copolymer), like hydrophobic chemicals, and combinations thereof.

A variety of fluorochemical, fluid repellent compounds suitable for use in accordance with embodiments of the present invention are known and are commercially available. One particular group of fluorochemical repellents are the polymers obtained by polymerizing an ethylenically unsaturated fluorochemical compound. The ethylenic unsaturation may be either in the alcohol or the acid portion of the ester molecule. Typically, the unsaturated radical in the alcohol portion of the ester may be the allyl radical or the vinyl radical. Typical unsaturated acids used to prepare the ester include acrylic acid, methacrylic acid and crotonic acid. In general, the perfluoro portion of the molecule is in the saturated portion of the molecule. The unsaturated portion of the molecule is typically not fluorinated in each instance. The acid and alcohols radicals may suitably contain from 2 to 6 carbon atoms excluding the carbonyl carbon of the acid. Examples of such monomers include vinyl perfluorobutyrate and perfluorobutyl acrylate. These monomers may be polymerized as homopolymers or as copolymers by normal emulsion polymerization techniques using free radical catalysts.

Examples of other suitable fluorochemical repellents for use in embodiments of the invention are those known and sold under the trademarks “Scotchgard® FC 208”, “Scotchgard® FC 210”, “Scotchgard® FC 232”, and Scotchgard® FC 319”, manufactured by the 3M Company, “Zepel™ B” manufactured by E. I. DuPont de Nemours and Co. and “Tinotop™ T-10” manufactured by Ciba-Geigy Ltd.

Of these materials “Scotchgard® FC 208” is an aqueous nonionic emulsion containing approximately 28% by weight of a modified fluorinated acrylic polymer: a substance believed to be of the following approximate general formula:

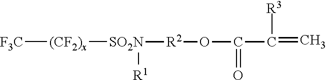

in which X is a value between 3 and 13 inclusive, R₁ is lower alkyl, such as methyl, ethyl, propyl, and the like, having 1-6 atoms R₂ is alkylene containing 1-12 carbon atoms and R₃ is H, methyl or ethyl. The product “Zepel™” is also available in emulsion form and while it is chemically different from the “Scotchgard®” products, it is a fluorochemical oil repellent containing fluorocarbon tails composed of CF₂ groups which may end in a terminal CF₃ group.

“Scotchgard® FC-319” is a solution of a compound similar to “FC-208” in an organic solvent. “Scotchgard® FC-232” is a dispersion of a fluorochemical resin in a mixture of water and methyl isobutyl ketone. “Zepel B™” is an aqueous cationic dispersion of a fluorochemical resin and is a product of E. I. Dupont de Nemours and Company. These products are believed to fall within the classes of compounds disclosed in the following patent specifications (compound descriptions incorporated herein by reference in their entirety): UK Pat. No. 971,732; Canadian Pat. No. 942,900; Canadian Pat. No. 697,656; French Pat. No. 1,568,181; French Pat. No. 1,562,070; German Pat. No. 1,419,505; U.S. Pat. No. 2,803,615; U.S. Pat. No. 2,826,564; U.S. Pat. No. 2,642,416; U.S. Pat. No. 2,839,513; U.S. Pat. No. 2,841,573; U.S. Pat. No. 3,484,281; U.S. Pat. No. 3,462,296; U.S. Pat. No. 3,636,085; U.S. Pat. No. 3,594,353; and U.S. Pat. No. 3,256,230.

Fluorolink® 5049 is a composition containing an anionic perfluoropolyether (PFPE) based polyurethane dispersion in water, polytetrafluoroethylene (PTFE) dispersion, isopropyl alcohol and methyl ethyl ketone, and is available from Solvay Solexis, Thorofare, N.J. Fluorolink® S10 is a composition containing a perfluoropolyether (PFPE)-based triethoxysilane dispersion in water, available from Solvay Solexis.

Wax dispersions for use as the hydrophobic chemical in accordance with embodiments of the invention, or as a supplement to a primary hydrophobic chemical (e.g., Freepel® 1225), include water-based wax dispersions such as, but are not limited to, synthetic wax (such as Freepel 11225 available from Noveon, Inc., Cleveland, Ohio); polyethylene wax (such as Michem™ ME available from Michelman, Cincinnati, Ohio; Luwax™ AF available from BASF, Parsippany, N.J.; Aquatec™ available from Eastman Chemical, Kingsport, Tenn.; and Jonwax™ available from S.C. Johnson Wax, Racine, Wis.); oxidized polyethylene wax (such as PoligenT WEI available from BASF, Parsippany, N.J.); ethylene acrylic acid copolymer EAA wax (such as Poligen™ WE available from BASF Parsippany, N.J.); ethylene vinylacetate copolymer wax (such as Aquacer™ available from BYK, Wallingford, Conn.); modified polypropylene wax (such as Aquaslip™ available from Lubrizol, Wickliffe, Ohio); silicone wax (such as DC 2503, DC2-1727, DC C-2-0563, DC 75SF and DC 580 available from Dow Corning, Midland, Mich.); Masilwax™ (available from Noveon, Cleveland, Ohio); Silcare™ 41 M (available from Clariant, Charlotte, N.C.); fluoroethylene wax (such as Hydrocer™ available from Shamrock, Newark, N.J.); Carnauba wax (such as Slip-Ayd™ SL available from Daniel Products, Jersey City, N.J.); Fischer-Tropsch wax (such as Vestowax™ available from Degussa, Ridgefield, N.J.); and ester wax (such as Luwax™ E available from BASF, Parsippany, N.J.; and Lipowax™ available from Lipo, Paterson, N.J.), like waxes, and combinations thereof.

Optionally, fillers, resins, processing aids, cross-linkers, catalysts for cross-linking polymeric, elastomeric, or latex materials, such as natural rubber (NR), polychloroprene (CR), acrylonitrile butadiene copolymer (NBR) (such as carboxylated acrylonitrile butadiene copolymer), polyisoprene (PI), polyurethane (PU), styrene-butadiene, butyl rubber (copolymer of isobutylene with isoprene, or polymer of isobutylene), or combinations thereof and the like, as discussed above, can be used to further enhance the repellency and durability. These additional components can be incorporated within any elastomeric, polymeric, or latex compositions, which are then used with the hydrophobic chemical components of embodiments of the present invention to form a surface treated glove. Also, in certain embodiments, the elastomer for the unfoamed or foamed polymeric glove is predominantly NBR. In certain embodiments it is substantially (90% or more by weight) NBR.

In at least one embodiment of the invention, the polymeric glove may be formed of latex having commonly used stabilizers such as potassium hydroxide, ammonia, sulfonates, and the like, which may be incorporated within any composition described herein. And, in at least one embodiment, the latex may contain other commonly used ingredients such as surfactants, anti-microbial agents, fillers/additives and the like. For NBR formulations, acrylonitrile content can in certain embodiments be, for example, 28-34%, 35-37%, or 38-42%.

A fluid repellent coating, for example, a polymeric glove (or polymeric coating on a fabric liner of a supported glove) comprising a barrier coating, can be between about 10-20 mil (single-walled thickness) that provides protection against liquid permeability. Such gloves comprise, for example, NBR, NR, PI, CR, and PU, as discussed above, and further comprise a flow modifier (e.g., styrene-mono secondary butyl maleate-monomethyl maleate-maleic anhydride polymer), curative agents, germicide, pigments, and water.

Embodiments according to the invention include the use of a dispersion that comprises microparticles, for example, silica particles functionalized with fluorine chemistry, for example, HeiQ® Barrier RCF, and a fluorocarbon to promote the uniform dispersion of the microparticles, such as HeiQ® Barrier HM (both obtained from HeiQ® Materials AG). HeiQ® Barrier HM is a liquid formulation containing fluorine resin chemistry and auxiliary components to promote uniform coverage on the treatment surface. HeiQ® Barrier RCF is a liquid formulation containing specially engineered silicon dioxide (silica) particles that are functionalized with fluorine chemistry in amounts effective to increase fluid repellency on the exterior surface relative to the same barrier having only the hydrophobic chemical (in similar amounts). After forming the barrier article (after forming an elastomeric glove or coated fabric glove, by, for example, a dipping process) or, alternatively, using a pre-formed barrier article, the article is dipped into a formulation (for example, an aqueous formulation) of the hydrophobic micro-particles and/or the hydrophobic chemical. For example, a useful combination of hydrophobic micro-particles and hydrophobic chemical is HeiQ® Barrier RCF (for example at 10-100 g/L), and HeiQ® Barrier HM (for example at 20-110 g/L). If separate formulations are used, the hydrophobic chemical formulation can usefully be dipped second. Also, because the formulations are suspensions, stirring during dipping can be helpful.

The inner and outer gloves can be spot joined, such as by adhesive, heat fusion, spot welding, or the like. Adhesive joining can be with a heat-activated adhesive that is spot applied to one of the gloves, and activated when the gloves are layered, such as by IR lamp.

The exterior environment is a likely source of contamination, making it important to detect breaches in outer layers of a glove system. However, interior breaches also make the surgical worker (or the like) more vulnerable. As the surgical worker has worn the glove system for a period of time, some sweat builds, and provides the hydrophilic or aqueous fluid that creates the detectable contrast. Tests have shown that damp hand, analogous to hands with a small amount of sweat, are sufficient to create the warning contrast when there is a pin-hole in an inner glove.

### Process

The process of forming the hydrophilic surface can include:

TABLE A
Applying a solution containing from about 0.05% to about 2% wt alkyl-
aryl compound having a pendent from aryl one to two oxy-polymers, and
optionally from about 0.01% to about 1% wt (a) a poly-oxyalkylene
polymer that is predominantly oxyethylene or (b) a polyvinyl alcohol;
and
Drying the glove surface.

### Tests

Various tests were performed on several gloves, including polyisoprene, natural rubber, and polychloroprene, according to embodiments of the invention as well as non-treated gloves for controls. Visual indicia of the efficacy of treatments according to the invention are shown and are labeled Experimental or Treated while prior art gloves are labeled Conventional or Control.

Visual repellency test with water: Glove according to embodiments of the invention and control gloves were mounted onto a former and immersed into an aqueous solution containing water and red pigment (Farsperse Red PR1123). Immediately after the withdrawal of each sample, the effect of water repellency on the glove surface was photographed.

Visual repellency test with human blood: Expired human blood sample (Type O, 2 months expired) collected from National Blood Bank, Kuala Lumpur, Malaysia was used for the test. Treated and control gloves were mounted onto a handed former and immersed in human blood at approximately 20° C. and withdrawn. Immediately following withdrawal, the glove surface was photographed showing the effect of blood repellency on the glove surface. The glove surface was then photographed again after 5 minutes.

Contact angle test: The liquid spread-ability of the glove surface was determined by a contact angle meter (AST Optima XE Video Contact Angle System, AST Products Inc.) by dropping a drop of water and measuring the contact angle of the liquid on the elastomer surface immediately and after 5 seconds. The measurement was done automatically by the contact angle meter. The measurement conditions were temperature 23+2° C.; relative humidity 55%+10%.

Tensile properties test: Tensile properties of control and treated gloves were tested according to ASTM D412. Tensometer Monsanto T10 was used to conduct the tensile test and dumbbell die cutter C was used. The accelerated aging of test specimens was carried out in accordance with ASTM D537-04. Irradiation created by Cobalt-60 Gamma ray source minimum dose of 2.5 mrads was used to sterilize the glove samples.

### EXAMPLE 1

The following composition was used:

TABLE 1

| Component | Percent (wt)(%) |
|---|---|
| Alkyl Phenol Ethoxylate, Av. carbon chain | 1.0 |
| 17, Av. ethoxy no. 80 | |
| Glycerin (99%) | 0.2 |
| Water | 98.8 |

The steps to be applied to the outer surface of the inner glove are:

TABLE 2
Protocol

(a) The solution of Table 1 is prepared by mixing and stirring at room
temperature until it becomes homogeneous.
(b) Synthetic polyisoprene surgical glove from the dipping machine is
washed clean with water in a washer to remove the mold-release agent
(calcium carbonate) and is dried in a tumbler dryer.
(c) The gloves are then dipped or soaked in the solution of Table 1
and dried; Or, alternatively, the solution is sprayed onto the glove
surface in an enclosed tumbler dryer followed by drying.
(d) The glove is then packed and sterilized by Gamma irradiation.
(e) The liquid spread-ability of the glove surface is determined by a
contact angle meter (AST Optima XE Video Contact Angle System, AST
Products Inc.) by dropping a drop of water and measuring the contact
angle of the liquid on the rubber surface immediately and after 5
seconds. The measurement is done automatically by the contact angle
meter. The measurement conditions are temperature 23 + 2° C.;
relative humidity 55% + 10%.
(f) The washed synthetic polyisoprene glove described in (b) is used
as a control sample
(g) The contact angle of a commercial polyisoprene surgical glove is
measured for comparison.

The above process, using the dipping step, achieved the following:

TABLE 3
Angle of water on various surfaces of different polyisoprene gloves

Contact angle, degree

| | Immediate, about | |
|---|---|---|
| Samples | 1 second | 5 seconds |
| Polyisoprene glove, | 90 | 74 |
| control sample without | | |
| coating | | |
| Commercial polyisoprene | 125 | 119 |
| glove, standard thickness | | |
| Polyisoprene glove with | 31 | 20 |
| hydrophilic coating of 1% | | |
| alkyl phenol ethoxylate & | | |
| 0.2% Glycerine | | |

### EXAMPLE 2

Comparative and Experimental Gloves (of the invention) were compared for the strength of the visual indicator of breach. Combination glove pairs were punctured in the outer glove with a needle and dipped in water to the same depth. Pictures were taken at 30 seconds (A) and 5 minutes (B), as outlined below:

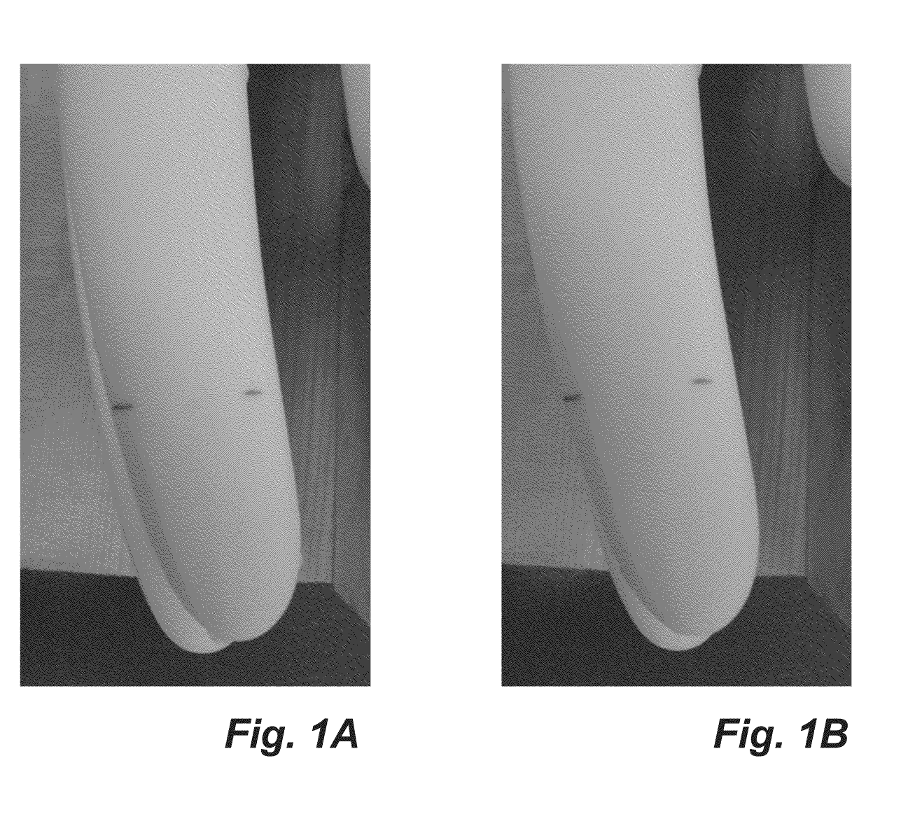

TABLE 4
FIG. 1: Comparative

| | |
|---|---|
| Outer Glove: Ansell Hi-Viz surgical | Inner Glove: Ansell's |
| (with liquid repellent coating) | Polyisoprene glove standard |

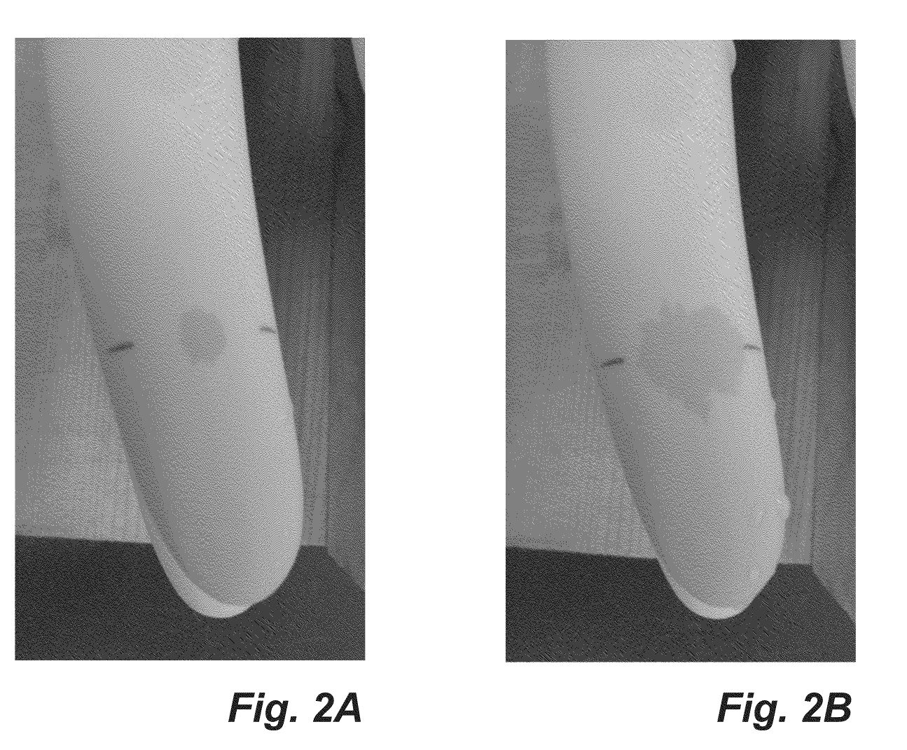

FIG. 2: Comparative

| | |
|---|---|
| Outer Glove: Ansell Hi-Viz surgical | Inner Glove: Ansell's |
| (with liquid repellent coating) | Polyisoprene micro thin glove |

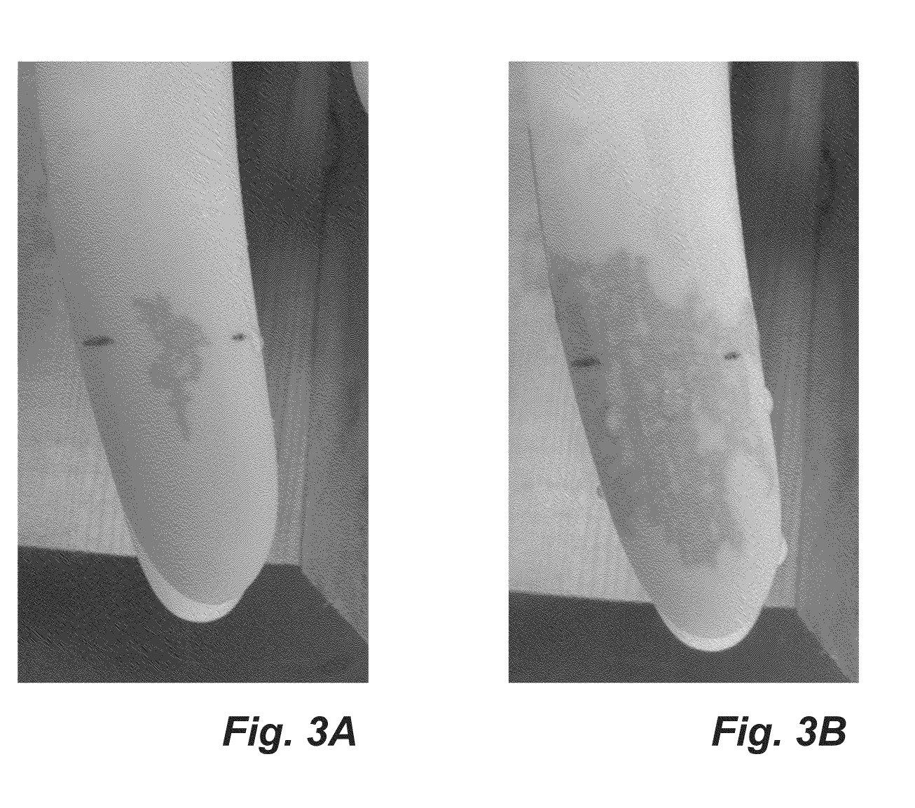

FIG. 3: Comparative

| | |
|---|---|
| Outer Glove: Ansell Hi-Viz surgical | Inner Glove: Mölnlycke Health |
| (with liquid repellent coating) | Care's Biogel PI Indicator |
| | Underglove |

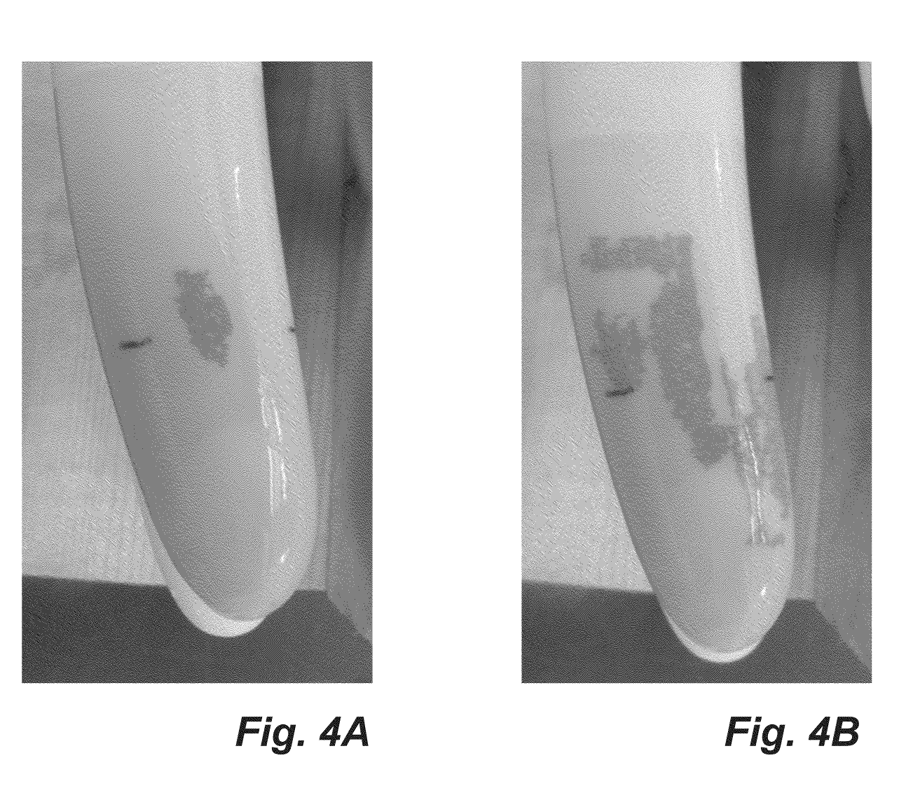

FIG. 4: Comparative

| | |
|---|---|
| Outer Glove: Mölnlycke Health | Inner Glove: Underglove - |
| Care's Biogel Non-Latex | Mölnlycke Health |
| Polyisoprene glove | Care's Biogel Polyisoprene |
| | glove Indicator Underglove |

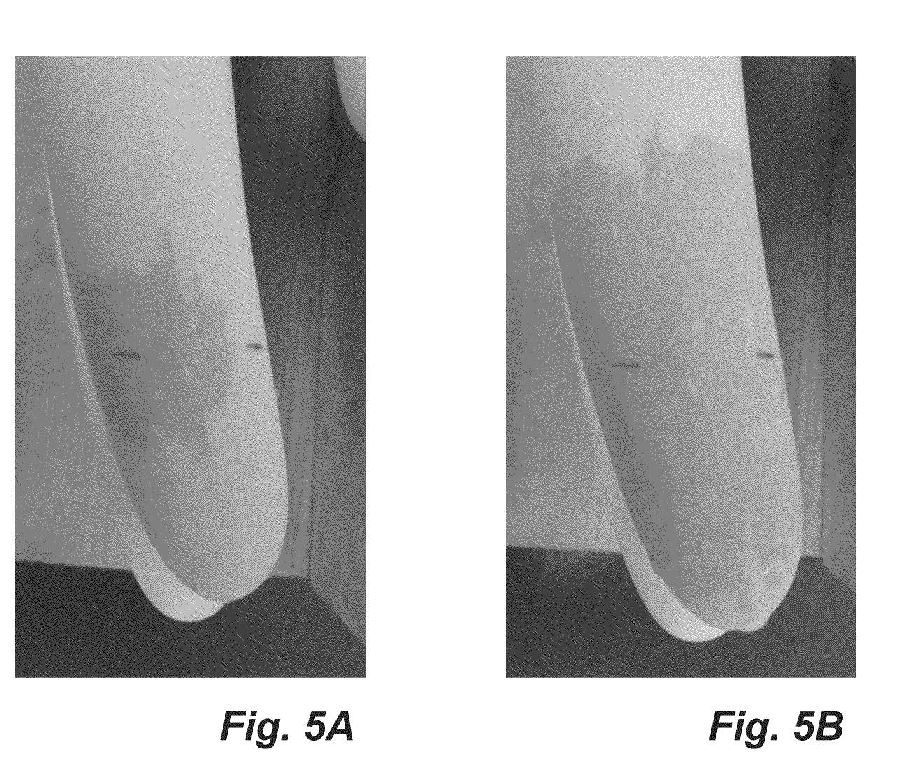

FIG. 5: Experimental

| | |
|---|---|
| Outer Glove: Ansell Hi-Viz surgical | Inner Glove: Prototype 1 with |
| (with liquid repellent coating) | hydrophilic coating on the outside |
| | surface |

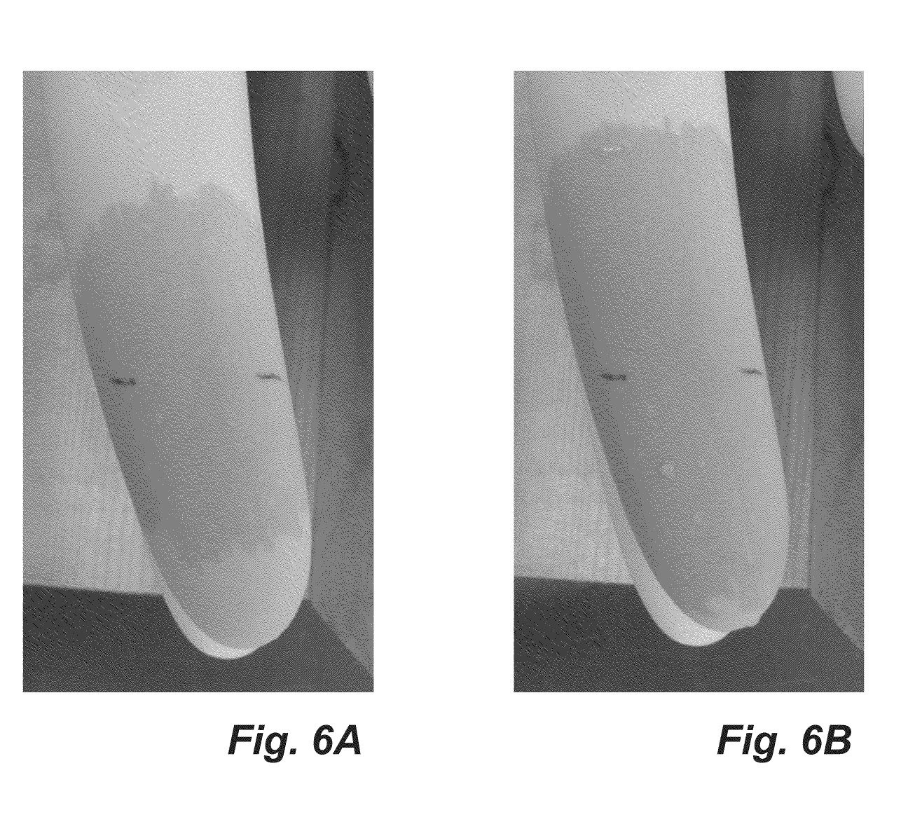

FIG. 6: Experimental

| | |
|---|---|
| Outer Glove: Ansell Hi-Viz surgical | Inner Glove: Prototype 2 with |
| (with liquid repellent coating) | hydrophilic coating on the outside |
| | surface |

### EXAMPLE 3

Various formulations of the invention were used to render hydrophilic a coating that otherwise would have been hydrophobic. The first formulation is that which would render a surface hydrophobic. The remaining formulations have the added formulation to render the elastomer surface hydrophilic. Water contact angles for the treated elastomer measured a 1 and 5 seconds, as measured by video image capture:

| | Contact | Contact |
|---|---|---|
| | angle - | angle - |
| Material by weight | 1 s (°) | 5 s (°) |
| Control - | 89.8 | 73.6 |
| Dow Corning silicone 365 = 0.4%, | | |
| Dow Corning silicone 939 = 0.3%, | | |
| Michem Emulsion 43040 polypropylene wax¹ = 0.5% | | |
| Sample 1 - | 52.5 | 31.8 |
| Dow Corning silicone 365 = 0.1%, | | |
| Dow Corning silicone 939 = 0.1%, | | |
| Michem Emulsion 43040 polypropylene wax = 0.1%, | | |
| Glycerine = 0.04%, | | |
| Ethoxylated alkyl phenol = 1% | | |
| Sample 2- | 61.6 | 44.5 |
| Dow Corning silicone 365 = 0.2%, | | |
| Dow Corning silicone 939 = 0.2%, | | |
| Michem Emulsion 43040 polypropylene wax = 0.2%, | | |
| Glycerine = 0.04% | | |
| Ethoxylated alkyl phenol = 1% | | |
| Sample 3- | 59.9 | 13.8 |
| Glycerine = 0.04%, | | |
| DC500W = 1.5% (3-(3-Hydroxypropyl) - | | |
| heptamethyltrisiloxane, ethoxylated, acetate)² | | |
| Sample 4- | 77.0 | 24.2 |
| Glycerine = 0.04% | | |
| Algene N40 = 0.2% (Alkyl trimethyl | | |
| ammonium bromide)³ | | |
| Sample 5- | 37.8 | 13.2 |
| Glycerine = 0.04% | | |
| Silsurf A008 = 0.2% (ethoxylated | | |
| polydimethylsiloxane)⁴ | | |

¹Michem Emulsion from Michelman Inc., Cincinnati, OH.
²DC500W from Dow Corning.
³Algene N40 from Huntsman Corporation, Woodlands, TX.
⁴Siltech Corporation, Toronto, Canada.

### Numbered Embodiments

The invention can be described further with reference to the following numbered embodiments:

Embodiment 1. A combination glove for detecting breaches of hydrophilic or aqueous fluid comprising: (a) an top elastomer layer with an inner surface, namely the inner-top surface, the top elastomer layer being translucent or transparent; (b) an bottom elastomer layer with an outer surface, namely the outer-bottom surface, the bottom elastomer layer being darker than the top elastomer layer; and (c) a space or seam between the layers in which the hydrophilic or aqueous fluid can flow, wherein to either the inner-top or the outer-bottom surface has been applied a hydrophilicity promoting composition of (i) a polyvinyl alcohol or (ii) an alkyl-aryl compound or a siloxane compound having pendent one to two oxy-polymers, (iii) a quaternary amine including an alkyl of C8 to C24, or (iv) a mixture of the foregoing, wherein the oxy-polymer is (1) a poly-oxyalkylene polymer that is predominantly oxyethylene or (2) a polyvinyl alcohol, wherein the hydrophilicity promoting composition enhances the spreading in the space or seam of any of the hydrophilic or aqueous fluid that breaches the top or bottom elastomer layer.

Embodiment 2. The combination glove of embodiment 1, wherein the hydrophilicity promoting composition comprises (i) the polyvinyl alcohol.

Embodiment 3. The combination glove of embodiment 1, wherein the hydrophilicity promoting composition comprises (ii.1) the alkyl-aryl compound having a pendent one to two oxy-polymers.

Embodiment 4. The combination glove of embodiment 1, wherein the hydrophilicity promoting composition comprises (ii.2) the siloxane compound having a pendent one to two oxy-polymers.

Embodiment 5. The combination glove of embodiment 1, wherein the hydrophilicity promoting composition comprises (iii) the quaternary amine.

Embodiment 6. The combination glove of one of embodiments 1 to 5, wherein the top glove has an outer surface that has hydrophobic particles and hydrophobic fluorocarbon adhered thereto in amounts that limit the adherence of human blood.

Embodiment 7. The combination glove of embodiment 6, wherein the top glove outer surface has a further silicone composition.

Embodiment 8. The combination glove of one of embodiments 1 to 7, wherein the hydrophilicity promoting composition further comprises a hydrophilic compound of carbon, hydrogen and oxygen wherein the carbon number is 2 to 8.

Embodiment 9. The combination glove of embodiment 8, wherein hydrophilic compound is a polyol.

Embodiment 10. The combination glove of one of embodiments 1 to 9, wherein one of the inner-top or the outer-bottom surface has said hydrophilicity promoting composition, and the other is treated to render it hydrophobic.

Embodiment 11. The combination glove of embodiment 10, wherein the hydrophobic surface comprises a sublayer of film-forming polymer and wax.

Embodiment 12. The combination glove of one of embodiments 1 to 11, wherein the two layers are spot joined at spaced-apart locations such that the combination glove can be donned as one glove, while retaining the space or seam needed for breach detection.

Embodiment 13. The combination glove of one of embodiments 1 to 12, wherein the immediate water contact angle on the surface with hydrophilicity promoting composition is 45 ° or less.

Embodiment 14. The combination glove of one of embodiments 1 to 13, wherein the 5 second water contact angle on the surface with hydrophilicity promoting composition is 30 ° or less.

Embodiment 15. The combination glove of one of embodiments 1 to 14, wherein the oxy-polymer is (a) a poly-oxyalkylene polymer that is predominantly oxyethylene.

Embodiment 16. The combination glove of one of embodiments 1 to 14, wherein the oxy-polymer is (b) a polyvinyl alcohol.

Embodiment 17. The combination glove of one of embodiments 1 to 14, wherein the outer-bottom surface has the hydrophilicity promoting composition.

Embodiment 18. The combination glove of embodiment claim 17, wherein hydrophilicity promoting composition further comprises a hydrophilic compound of carbon, hydrogen and oxygen wherein the carbon number is 2 to 8.

Embodiment 19. The combination glove of embodiment 18, wherein hydrophilic compound is a polyol.

Embodiment 20. The combination glove of one of embodiments 17 to 19, wherein the inner-top surface is treated to render it hydrophobic.

Embodiment 21. The combination glove of embodiment 20, wherein the hydrophobic surface comprises a sublayer of film-forming polymer and wax.

Embodiment 22. A method of conducting surgery comprising: (a) a surgical worker donning a combination glove of one of embodiments 1 to 21; and (b) conducting a medical procedure in which the combination glove is exposed to biological fluids from a patient.

Embodiment 23. The method of embodiment 22, further comprising: (c) the surgical worker removing the combination glove and replacing it with a second combination glove when the first combination glove darkens consistent with there being aqueous fluid between the top and bottom elastomer layers.

Embodiment 25. For all of the glove embodiments, the combination glove packaged (e.g., box, sealed tear package configured to hold the gloves for both hands) with the bottom elastomer layer substantially inserted in the top elastomer layer.

Embodiment 26. For Embodiment 26, wherein the packaged top and bottom elastomer layers are inserted so as to make a double-layer glove, but with the cuffs downfolded over the double layer glove to facilitate donning the double layer glove.

All ranges recited herein include ranges therebetween, inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4 . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent ranges starting at integer values at the recited order of magnitude or one lower, e.g., 3 or more includes 4 or more, or 3.1 or more.

The foregoing description of embodiments of the invention comprises a elements, devices, machines, components and/or assemblies that perform various functions as described. These elements, devices, machines, components and/or assemblies are exemplary implementations of means for performing their functions.

Although only a few exemplary embodiments of the present invention have been described in detail above, those skilled in the art will readily appreciate that many modifications are possible in the exemplary embodiments without materially departing from the novel teachings and advantages of this invention.

What is claimed is:

1. A combination glove for detecting breaches of hydrophilic or aqueous fluid comprising:
an top elastomer layer with an inner surface, namely the inner-top surface, the top elastomer layer being translucent or transparent;
an bottom elastomer layer with an outer surface, namely the outer-bottom surface, the bottom elastomer layer being darker than the top elastomer layer; and
a space or seam between the layers in which the hydrophilic or aqueous fluid can flow,
wherein to either the inner-top or the outer-bottom surface has been applied a hydrophilicity promoting composition of (i) a polyvinyl alcohol or (ii) an alkyl-aryl compound or a siloxane compound having a pendent one to two oxy-polymers, (iii) a quaternary amine including an alkyl of C8 to C24, or (iv) a mixture of the foregoing, wherein the oxy-polymer is (1) a poly-oxyalkylene polymer that is predominantly oxyethylene or (2) a polyvinyl alcohol,
wherein the hydrophilicity promoting composition enhances the spreading in the space or seam of any of the hydrophilic or aqueous fluid that breaches the top elastomer or bottom layer.

2. The combination glove of claim 1, wherein the hydrophilicity promoting composition comprises (i) the polyvinyl alcohol.

3. The combination glove of claim 1, wherein the hydrophilicity promoting composition comprises (ii.1) the alkyl-aryl compound having a pendent one to two oxy-polymers.

4. The combination glove of claim 1, wherein the hydrophilicity promoting composition comprises (ii.2) the siloxane compound having a pendent one to two oxy-polymers.

5. The combination glove of claim 1, wherein the hydrophilicity promoting composition comprises (iii) the quaternary amine.

6. The combination glove of one of claim 1, wherein the top glove has an outer surface that has hydrophobic particles and hydrophobic fluorocarbon adhered thereto in amounts that limit the adherence of human blood.

7. The combination glove of claim 6, wherein the top glove outer surface has a further silicone composition.

8. The combination glove of claim 1, wherein the hydrophilicity promoting composition further comprises a hydrophilic compound of carbon, hydrogen and oxygen wherein the carbon number is 2 to 8.

9. The combination glove of claims 1, wherein one of the inner-top or the outer-bottom surface has said hydrophilicity promoting composition, and the other is treated to render it hydrophobic.

10. The combination glove of claim 9, wherein the hydrophobic surface comprises a sublayer of film-forming polymer and wax.

11. The combination glove of claim 1, wherein the two layers are spot joined at spaced-apart locations such that the combination glove can be donned as one glove, while retaining the space or seam needed for breach detection.

12. The combination glove of claim 1, wherein the immediate water contact angle on the surface with hydrophilicity promoting composition is 45° or less.

13. The combination glove of claim 1, wherein the 5 second water contact angle on the surface with hydrophilicity promoting composition is 30° or less.

14. The combination glove of claim 1, wherein the oxy-polymer is (a) a poly-oxyalkylene polymer that is predominantly oxyethylene.

15. The combination glove of claim 1, wherein the oxy-polymer is (b) a polyvinyl alcohol.

16. The combination glove of claim 1, wherein the outer-bottom surface has the hydrophilicity promoting composition.

17. The combination glove of claim 16, wherein hydrophilicity promoting composition further comprises a hydrophilic compound of carbon, hydrogen and oxygen wherein the carbon number is 2 to 8.

18. The combination glove of claim 16, wherein the inner-top surface is treated to render it hydrophobic.

19. The combination glove of claim 18, wherein the hydrophobic surface comprises a sublayer of film-forming polymer and wax.

20. A method of conducting surgery comprising:
a surgical worker donning a combination glove of claim 1; and
conducting a medical procedure in which the combination glove is exposed to biological fluids from a patient.
